(19) United States
(12) Patent Application Publication
(10) Pub. No.: US 2013/0311556 A1
(43) Pub. Date: Nov. 21, 2013

(54) System and Method for Generating Theme Based Dynamic Groups

(71) Applicants: Piyush Kumar Srivastava, Bangalore (IN); Ashootosh Chand, Bangalore (IN)

(72) Inventors: Piyush Kumar Srivastava, Bangalore (IN); Ashootosh Chand, Bangalore (IN)

(73) Assignee: Yahoo! Inc., Sunnyvale, CA (US)

(21) Appl. No.: 13/475,905

(22) Filed: May 18, 2012

(51) Int. Cl. G06F 15/16

(52) U.S. Cl. 709/204

(57) ABSTRACT

Methods, system and computer readable medium for generating a dynamic group includes defining a theme for the group. A group is initiated for the defined theme and plurality of users are invited to join the group. The activities of the plurality of users that have joined the group are monitored over time, wherein the activities are directed toward enriching information associated with the defined theme or one or more sub-themes of the defined theme. User dynamics of the group are adjusted dynamically based on the monitored activities of the users. The adjusted user dynamics define a strength value of the theme for the group of users.

### BACKGROUND

1. Field of the Invention

The present invention relates to communication amongst groups of individuals, and more particularly, to generating dynamic groups that is relevant to a specific theme.

2. Description of the Related Art

Various social platforms have been provided to users to build, integrate and facilitate social interaction of users on the Internet. These social platforms provide tools that act as Internet forum or online message/boards/groups to engage user interaction. The boards, groups or forums allow digital interaction by enabling a group of users to post messages and comment on other messages or articles using interaction tools, such as emails, message blogs, etc. The primary problem with such groups is that most of the group-based and social online solutions do not sustain beyond a few weeks or months. Further, these social platforms are usually built based on static relationship of people, thereby becoming a mere extension of the real-world connections and relationships. Additionally, these groups are formed for generic interactions related to various themes and are not specific to any particular subject/theme. As a result, the subject matter for the boards/groups/forums keep changing randomly making it practically impossible to extract a specific theme from these interactions. Additionally, due to the generic nature of these interactions, users on these boards/groups/forums receive random messages from different users including messages that may be totally unrelated to the topics being discussed by the group or messages that are not generally wanted by the users. Such messages may be marked as spam messages by some members defeating the purpose of sending these messages.

Contrary to the design of conventional social platform tools, virtual world interactions need not have to reflect or be constrained by the real-world connections and relationships. Such restrictions would reduce the richness in the content of the group. It would, therefore, be desirable to enhance the richness of content within the group by opening the group to a larger audience of users. It would also be desirable to provide more focused theme-based groups so as to attract correct set of users that are interested in the group's theme who can actively contribute and enrich the content in the group and who can rely on and share the enriched content resources of the group. It would also be useful to develop a social interaction tool that would address the issue of receiving unwanted messages from members that seldom contribute.

It is in this context that the embodiments of the invention arise.

### SUMMARY

Embodiments of the present invention address the various design issues of the conventional boards/groups/forums provided by various social platform tools by defining a method, an algorithm and a system for generating a dynamic group for a specific theme. The dynamic group enables a user to expand their social circle beyond the static relationship confinement established by their social contact list. The dynamic group is theme-based enabling highly focused participation by the members of the group resulting in rich source of information that is highly relevant to the theme of the group. Due to the highly focused approach established by the theme-based group, most of the spam related issues that have generally been an issue with the conventional groups are successfully addressed. The groups are dynamic in nature making it possible for the group to grow or shrink in size, merge or de-merge so as to maintain focus in the group.

It should be appreciated that the present invention can be implemented in numerous ways, such as, methods, systems and computer readable medium. Several inventive embodiments of the present invention are described below.

In one embodiment, a method for generating a dynamic group is disclosed. The method includes defining a theme for the group. A group is initiated for the defined theme and plurality of users are invited to join the group. The activities of the plurality of users that have joined the group are monitored over time, wherein the activities are directed toward enriching information associated with the defined theme or one or more sub-themes of the defined theme. User dynamics of the group are adjusted dynamically based on the monitored activities of the users. The adjusted user dynamics define a strength value of the theme for the group of users.

In another embodiment, a computer readable medium encoding program instructions for generating a dynamic group is provided. The computer readable medium includes program instructions for defining a theme for the group. The computer readable medium further includes program instructions for initiating the group for the defined theme. The program instructions also include instructions to invite a plurality of users to join the group and to monitor activities of the users that have joined the group, wherein the activities are directed toward enriching information associated with the theme or one or more sub-themes of the defined theme. Program instructions for adjusting user dynamics of the group based on the monitored activities of the users, are also provided. The adjustment in the user dynamics define a strength value of the theme for the group of users belonging to the group.

In yet another embodiment, a system for enabling a private conversation for a content published on a website is disclosed. The system includes a dynamic group generator module configured to execute on a server to, (a) initiate a group for a theme defined by a user; (b) invite a plurality of users to join the group; (c) monitor activities of the invited users that have joined the group, wherein the activities serve to enrich information associated with one or more sub-themes of the defined theme; (d) compute participation score of each user in the group based on number of activities of the respective user; and (e) adjust user dynamics of the group based on the computed participation score associated with the plurality of users, the adjusted user dynamics defining a strength value of the theme as it relates to the users of the group.

The embodiments of the invention provide an efficient tool to generate a group that is more content rich and focused on a defined theme. The members of the group actively contribute to enrich the content of the group. The users are able to use myriads of social interactive tools, such as emails, blog tools, messenger tools, etc., to generate interactions that can support various activities related to collaboration of resources, such as discussion threads, emails, blog posts, messages, comments, etc., and sharing of resources around the theme, such as videos, books, links, pictures, ratings, reviews, events, articles, etc., within the group and such activities are updated, monitored and used to adjust the user dynamics so as to enhance and enrich the content and contribution to the group.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIG. 1 illustrates a simple block diagram of a system identifying various modules used in enabling a private conversation for a content provided on a website, in one embodiment of the invention.

FIGS. 2a-2d illustrate the dynamic theme-based group that is generated, in one embodiment of the invention.

FIG. 3 illustrates a flow chart of process flow operations for generating theme-based dynamic group, in one embodiment of the invention.

FIGS. 4a-4c illustrate exemplary graphs plotting strength value of the dynamic group over time, in one embodiment of the invention.

### DETAILED DESCRIPTION

Broadly speaking, the embodiments of the present invention provide methods, system and computer readable medium that utilizes a mechanism provided on a server to generate a theme-based dynamic group. The mechanism on the server interacts with a client-side module to receive user interaction including a defined theme for initiating a dynamic group and to monitor the user interaction to adjust the user dynamics of the group. The adjustment to the dynamics of the group includes filtering out inactive users so only users that are actively contributing to enrich and share the content of the group are retained. The mechanism also allows for deactivating a group when the interactions within the group fall below a threshold value and archiving the contents for subsequent retrieval. Additionally, the deactivated group can be re-activated by the existing members or by new members joining the group and the contents retrieved from archives so that users can continue to contribute toward the theme of the reactivated group.

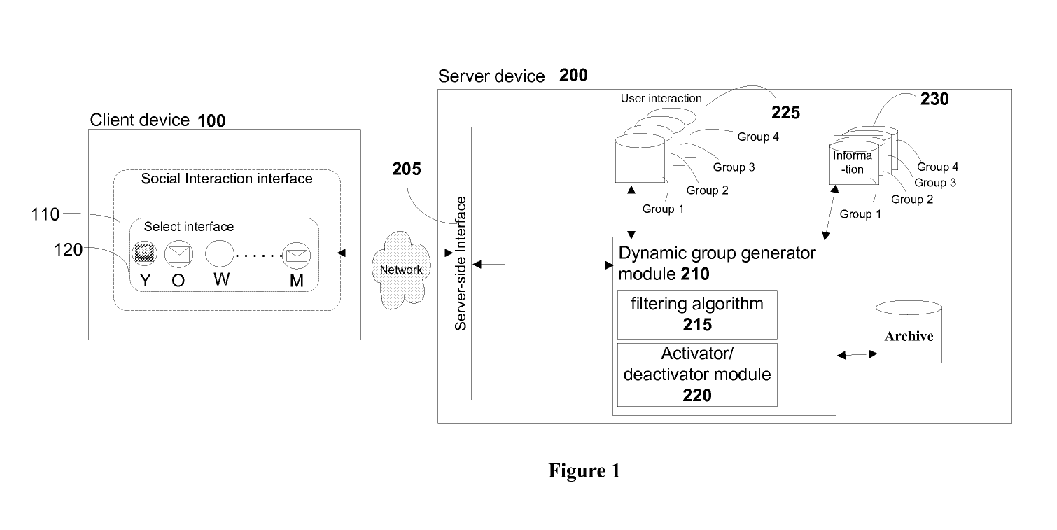

With the brief overview, various embodiments of the invention will now be described in detail with reference to the figures. FIG. 1 illustrates a simple block diagram of a system used in generating a dynamic group. The system includes a server device equipped with a dynamic group generator module 210 that interacts with a client device 100 to receive user actions and interactions. The client device 100 includes a social interaction interface module 110 for receiving and transmitting user input to the server device 200. The user input is used in generating/updating a dynamic group at the server device. In one embodiment, the social interaction interface 110 identifies an entity that provides necessary tools for generating a request and for accessing and providing information to a group. The entity includes one or more entity driven (i.e. entity supported) social interaction tools that are available to a user for generating the request to create the group, for providing information via user interaction that is broadcasted to other users in the group and for updating the social interaction to the group. In one embodiment, the social interaction tools available within an entity may include one or more of an email tool, an outlook tool, a messenger tool, a weblog tool, photo or video sharing tool, etc., to enable a user to provide user interactions, such as comments, views, ratings/reviews, message blogs, emails, and to share videos, photos, books, links, pictures, articles, etc. The above list of tools and interactions are exemplary and should not be considered restrictive. The user interactions received at the client-side through the social interaction tools are transmitted over a network, such as the Internet, to the server device 200.

The server device 200 includes a server-side interface 205 that receives the transmitted interactions from the entity driven interaction interface 110 of the client device 100 and forwards these interactions to a dynamic group generator module (or simply a “generator module”) 210 for processing. The generator module 210 analyzes the interaction to determine if there is a request to generate a new group from a user. In one embodiment, the group may be a discussion group or any other type of group that enables social collaboration. The interaction received from the client device 100 includes information that identifies a theme for which a new group is requested by the user. In one embodiment, the information may also include rules and regulations to guide user interactions within the group provided by the user. These rules and regulations are used to define the policies and principles of operation and interaction governing the group. In response to the request, the generator module 210 creates a group for the specified theme and defines the policies and principles based on the rules and regulations provided in the information. In another embodiment, the information received from the client device 100 may not include any rules and/or regulations. In this embodiment, the generator module 210 may use a set of default policies and principles that are appropriate for the requested theme, to provide guidance to user interactions for the group. In addition to the creation of the group, the generator module 210 may send out an invitation to a set of users inviting the users to participate in the group. In one embodiment, the generator module 210 may receive a list of “invitees” from the user as part of the request for creating the group. In this embodiment, the generator module 210 may send an invitation to the list of invitees to join and participate in the group. In another embodiment, in addition to the list of invitees or in place of the list of invitees, the generator module 210 may access one or more contact lists of the requesting user to identify invitees and send an invitation to the invitees to join and participate in the group. Each of the social interaction tools within the entity may maintain distinct contact lists of the user and the generator module 210 may use the one or more of these distinct contact lists of the user to send out invitations to the invitees to join the group. In one embodiment, the identified invitees may, in turn, invite additional users, who then can invite additional users, and so on, thereby expanding the user base of the group. In one embodiment, the user who initiated the creation of the group may moderate the interactions of the various users in the group by enforcing the defined policies and principles of the group and may, in some embodiment, seek assistance of one or more of the invitees in moderating the group, depending on the size of the membership, the amount of interactions, expertise of the invitees, etc.

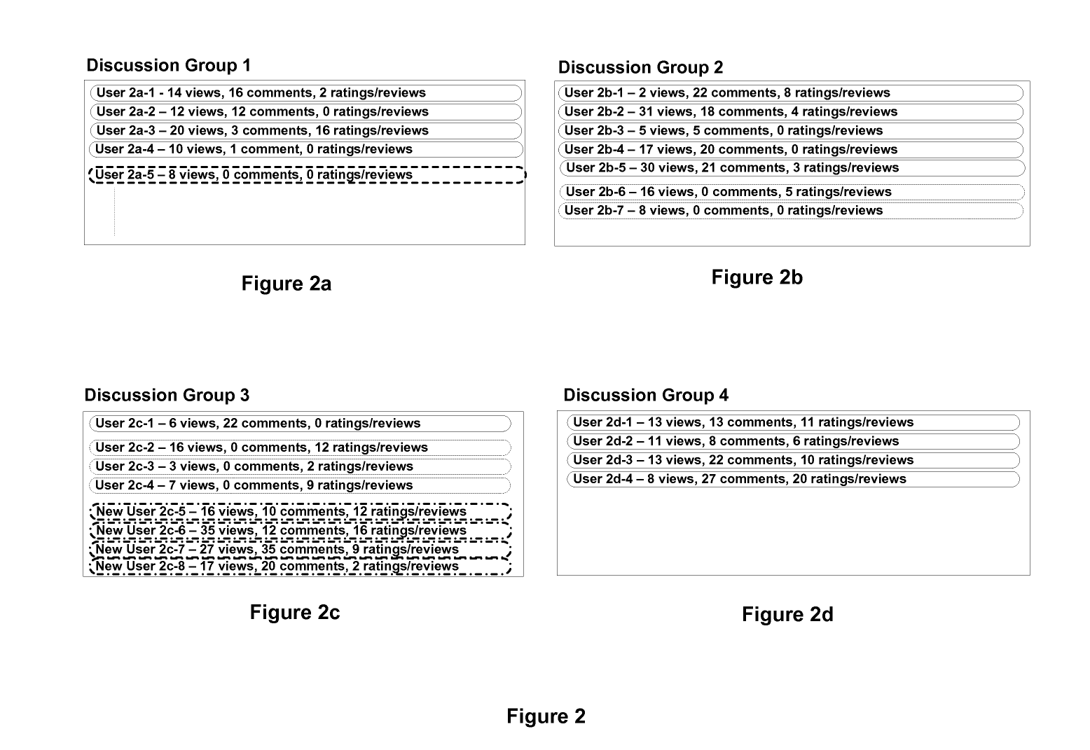

Once the group is created for the identified theme, the users may begin interacting and collaborating within the group. The user interactions and collaborations relate to the identified theme or to one or more sub-themes within the identified theme and generate information that is focused and rich in content. The generator module 210 monitors the user interactions and collaborations and adjusts the user dynamics of the group based on the monitored interactions. During the monitoring of the various interactions and collaborations, the generator module 210, in one embodiment, keeps track of the different type of interactions and collaborations and the number of each type of interactions and collaborations originating from each user who is a member of the group and stores such information in one or more databases for subsequent retrieval and analysis. FIGS. 2a-2d illustrate simplified renditions of various different groups with different types of interactions that the generator module 210 has captured over time for adjusting user dynamics, as will be discussed further below. For illustration purposes, each of the groups have been shown to have a few users and only interactions, while, in reality, each group can have tens, hundreds or even thousands of users based on the defined theme and the amount and type of information available in the respective groups include information shared through interactions and collaborations. In one embodiment, the user interactions and collaborations received by the generator module 210 for each group over time are stored in a user interaction database 225 under the respective group. Additionally, content information related to one or more sub-themes or the theme of the group may be stored in a distinctly separate information database 230 under the respective group, as illustrated in FIG. 1, or may be stored with other user interactions in the user interaction database 225. The stored interactions and information are periodically retrieved by the filtering algorithm 215 from the database(s) and analyzed to determine the level of participation of each user in the group over time.

The generator module 210 includes a filtering algorithm 215 to filter the users in the group based on the analysis of the monitored interactions. The filtering algorithm may identify the various types of interactions originating from a user, categorize the interactions into the respective types for each user, and compute a participation score for the user as a function of the type and number of interactions for each type. As mentioned earlier, the various types of interactions may include message blogs, emails, comments, ratings, reviews, etc. The aforementioned types of user interactions are exemplary and should not be considered restrictive. The filtering algorithm 215 may associate a certain weight to each type of interaction received for the theme/sub-themes and use this weight for computing the participation score of each user. In one embodiment, the filtering algorithm 215 may provide more weight to interactions, such as comments, weblogs, etc., that provide content to the group than interactions, such as ratings or reviews, etc., that do not provide any content but evaluates or provides feedback to the content.

Upon computing the participation score of each user, the filtering algorithm 215 may determine if any user needs to be filtered out of the group due to lack of participation or contribution to the group. In order to determine whether one or more users need to be filtered out of the group, the filtering algorithm 215 compares the computed participation score of the user with a pre-defined threshold value. When the participation score of the user is below the pre-defined threshold value, it is determined that the user has not significantly contributed to the group and needs to be removed from the group. As a result, the filtering algorithm uses an activator/deactivator algorithm 220, in one embodiment, to deactivate the user from the group.

In one embodiment, upon determining that the user's participation score is below the pre-defined threshold value and prior to actual deactivation of the user from the group, the filtering algorithm may send out a notification or a warning to the user indicating that the user's participation is below a threshold value and is targeted for termination from the group. This warning provides the user with an opportunity to increase his/her participation in the group in order to retain access to the information in the group. After the warning is issued, the filtering algorithm may wait for a pre-set period of time and then compute the participation score of the user to determine if the user's participation score has improved. If the participation score has improved, the filtering algorithm allows the user to continue in the group. If the participation score of the user has not improved from previous computation, the filtering algorithm may use the activator/deactivator algorithm 220 to deactivate the user from the group.

The filtering algorithm 215, thus, uses information from the captured interactions to adjust the user dynamics of the group. FIGS. 2a-2d illustrate the analysis, filtering and dynamically adjusting user dynamics of the group, including adding/removing users from the group. For instance, FIG. 2a illustrates a sampling of group 1 that includes users having varying types and amount of interactions as captured by the generator module 210. The information provided in FIG. 2a is obtained and accumulated by the generator module 210 from the user interaction database 225 and/or information database 230. The user interaction database 225 and the information database 230 act as a repository distinctly storing the user interactions and information received through collaborations for each group from various users over time. Based on the analysis of the various types of interactions, the filtering algorithm 215 determines that User 2a-5's interactions are only views and no comments or ratings/reviews. Further, the logic in the filtering algorithm may weigh contributions toward comment type indicated by number of comments, significantly higher than the contributions toward ratings or view types. As a result, the filtering algorithm 215 determines that User 2a-5 has not contributed content-wise to the group over time (i.e. zero comments), and targets User 2a-5 for deactivation, as illustrated by the dotted box in FIG. 2a. The deactivation prevents User 2a-5 from accessing any content resources available within the group. It should be noted that the computation of the participation score is carried out periodically and the user dynamics of the group adjusted in an ongoing manner so as to filter out non-active/non-contributing users. The resulting group includes only users who are active contributors that provide/share relevant information to the themes of the group. In addition to the automatic filtering by the filtering algorithm, active users may decide to voluntarily leave the group, in which case the filtering algorithm will deactivate those users. The filtering out of the users due to either explicit instructions from users or due to user non-participation would result in the shrinking of the size of the group.

As more and more users are filtered out and the group reduces in size, the generator module 210 may determine if the number of users and/or the number of interactions for the group fall below the pre-defined threshold value. In one embodiment, if the number of interactions and/or the number of users in the group fall below the threshold value, the generator module may deactivate the group so that the existing users of the group are no longer able to access the content and interact in the group. In this embodiment, the generator module may move the content accumulated for this group into an archive for later retrieval. Subsequently, when a request to revive the group is received from a user, the generator module 210 will retrieve the content and other information for the group from the archive and reactivate the group. The user may be one of the users that were active in the group before it was deactivated or may be a new user who has an interest in the theme of the group. The reactivated group is configured to receive the interactions from the users for the theme or for one or more sub-themes and to allow new users to join the group. In another embodiment, when the number of interactions and/or the number of users in the group fall below the threshold value, the generator module may delete the group. In this embodiment, the content related to the group may also be deleted.

The filtering algorithm may weigh and rank the various interactions differently based on the defined theme. For instance, for a particular theme, such as a group related to a medical field or a class, comments provided by different users may be ranked higher due to these comments providing information to the group. Additionally, the ratings and reviews may be ranked higher than the comments and the views may be ranked lower. This may be due to the fact that the ratings/reviews may be provided by an expert in the particular theme whose contributions tend to enrich the content while the views are by those that are just viewing and not necessarily contributing toward the content. In another group, such as a football game, the ratings/reviews may be provided by fans who may not be experts in the football game theme. As a result, the ratings/reviews may be weighed and ranked lower than the comments. It should be noted that the user interactions in the various embodiments discussed herein are focused only on three types of interactions, comments, ratings/reviews and views for illustrative purpose only. It should, therefore, be understood that there could be other types of interactions and collaborations and the logic within the filtering algorithm will weigh and rank these different actions and interactions accordingly. Thus, the filtering algorithm uses various attributes related to the theme of the group and the contributing users to weigh and rank the various interactions captured for the theme/sub-themes.

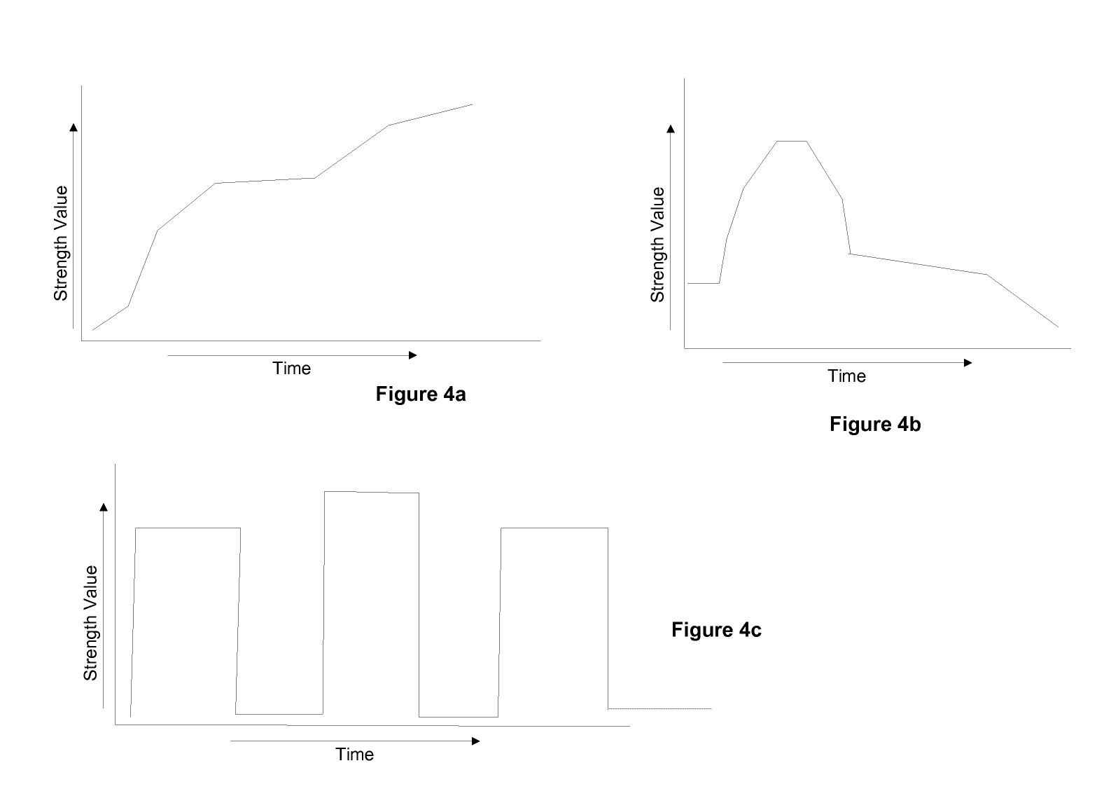

In addition to computing participation score for each user of the group, the filtering algorithm may use the participation score to compute a strength value of the group, in one embodiment. The strength value of the group defines the relevance of the interactions to the theme as reflected by the users participation by interaction. The filtering algorithm computes the strength value as a function of the participation score of the users that are identified as active contributing members of the group. As the participation score of each user varies over time, the strength value also varies over time. FIGS. 4a-4c illustrate some exemplary graph of strength value plotted against time for different group. For instance, as the users in the group continue to actively participate, the strength value of the group will increase, as illustrated in FIG. 4a. This might be the case with an ideal group illustrated in FIG. 2d. The flat sections in the graph may be due to leveling off of the users interactions. As illustrated in FIG. 4b, the strength value associated with a group starts increasing as soon as the group is created and after a while the user interactions start waning. This might be the case of a group that has local or short-lived theme, such as a Superbowl, world cup football, etc., as illustrated in FIG. 2b and discussed in detail in the following paragraphs. FIG. 4c illustrates a graph of a group with rising and falling strength values over time. This graph may relate to the classroom example illustrated in FIG. 2c and discussed in detail in the following paragraphs. As a new semester begins, the number of user interactions, and hence, the strength value based on participation score of the users, peaks and stays high over the semester period and drops at the end of the semester only to peak again at the beginning of a subsequent semester and repeating the cycle. In one embodiment, the users can decide to join or not join/leave the group based on the computed strength value of the group.

FIG. 2b illustrates an alternate sampling of a list of users in group 2 as analyzed by the generator module with the aid of the filtering algorithm. As discussed with reference to FIG. 2a, the filtering algorithm may, in one embodiment, determine that Users 2b-6 and 2b-7 are non-contributory members of group 2 and identify these users for deactivation. In this embodiment, even though User 2b-6's interaction includes some ratings/reviews in addition to a number of views, the filtering algorithm may include logic that determines that such interactions do not provide valuable content that enrich the information associated with the group. Consequently, based on the logic within the filtering algorithm and based on the group's attributes and the contributing users' attributes, Users 2b-6 and 2b-7 may be targeted for deactivation. In another embodiment, the filtering algorithm may recognize that User 2b-6 has indeed contributed toward enriching the content of the group by providing the necessary ratings/reviews to content provided by other users (as discussed with the medical theme above) while User 2b-7 has only viewed the content while not contributing in any other way to the group. In this embodiment, User 2b-7 is targeted for deactivation while User 2b-6 is allowed to remain as an active member of the group.

Alternately, new users may join the group individually or by merging groups, thereby allowing the group to grow in size. This dynamically adjusted group provides rich content for the declared theme and for the one or more sub-themes within the declared theme making it a rich source of relevant information that causes active and continual engagement of users. Due to the continual engagement of users, the dynamic groups can be a good source for promoting advertisements and other promotional media that are focused and relevant to the theme/sub-themes.

FIG. 2c illustrates an embodiment that seeks to expand the user base of a group. As illustrated in FIG. 2c, the group 3 may include a plurality of users with one user, User 2c-1, providing most of the content, as indicated by the number of comment type interactions while the remaining users, Users 2c-2 through 2c-4 providing interactions through views and ratings/reviews. This might be the case in a classroom group where a user initiating the group, such as a Professor, may provide all the necessary content for the class including powerpoint presentations, lecture videos, classroom notes, photos, blog posts, messages, comments, reviews, ratings, etc., and the remaining users are all students that view the information provided by the Professor and rate/review the presentations. The users (both Professor and students) may provide interactions in the form of blog posts, messages, pulses, comments, ratings, reviews, etc., using a myriad of social interaction tools available to the entity that is selected by each of the users for accessing and providing interaction at the group. In this embodiment, even though the students are not contributing to the content they are still retained as active members of the group. Thus, based on the policies and principles of the different groups, the filtering algorithm may determine which users to retain and which users to unsubscribe. In the classroom group illustrated in FIG. 2c, once the users have completed the course, the users may voluntarily leave the group or may be filtered out of the group, thereby shrinking the group. In one embodiment, the policies and principles of the classroom group may be temporal based with the users being automatically filtered out after passage of certain period of time, such as duration of course (i.e. after the semester is over). Alternately, the users may be automatically filtered out due to non-participation after a pre-set period of time has elapsed. In one embodiment, once the students leave the group either voluntarily or through explicit filtering, the policies may be defined such that the group is kept active even after the number of users and/or the amount of interactions fall below a pre-defined threshold value. In an alternate embodiment, the group may be archived after the semester ends and revived when a new semester begins for the course. When the group is revived by explicit instruction from the Professor, who acts as a moderator of the group, or from requests from new users, the generator module 210 will retrieve the previously generated course content from the archives and allow the new users to access the course content and provide interactions. Thus, as illustrated in FIG. 2c, old students represented by Users 2c-2 through 2c-4 leave the group and new students represented by Users 2c-5 through 2c-7 join the group and explore the enriched content. Additionally, as more new users join the group, the group grows in size.

FIG. 2d illustrates an exemplary ideal group that is generated and maintained by the generator module based on the interactions of the users toward the theme. Each of the users that remain in the group are active participants that continue to provide rich content and interactions that are relevant to the theme and one or more sub-themes. The users in the group remain due to their interest in the theme and are not dependent on real-world connections thereby enabling conversations/interactions that are focused and intense. As illustrated above, the group grows or shrinks depending on the number of users and their activity. Any interaction originating from a user, who is an active member is relevant to the group and is not considered a spam as they have joined the group due to their interest and not due to their connections.

In one embodiment, when more than one groups exist for a particular theme, the groups can be merged to generate a single group for the theme. More than one groups may exist, for instance, when the users of each of the groups are located in different geographies. As a result, based on a request from a user of a first group to a moderator of a second group, the first group may be merged into the second group. After the merger, the first group will be required to follow the policies and principles of the second group, if the first and the second groups' policies and principles are different. With the bigger group, the users can access greater amount of rich information that will make interactions amongst the bigger group of users that much more interesting and relevant.

It should be noted that as a group shrinks in size, the theme may be less relevant to the users and the group shrinks to oblivion. Initially, when a group is first created based on a request by a user, other users invited to participate in the group may be from direct connects of the requesting user, either provided explicitly or through address books/contact lists. The invited users may expand the user base of the group by extending invitations to other users that they feel are interested in the theme. As the group expands, a set of unrelated individuals come together to interact for a common theme and such interactions are relevant and intense as each user has joined the group because of their innate interest in the theme. As a result, the size of the group and the amount of content exchanged amongst the users exemplifies the strength value of the theme and the group's survival. groups having themes that are relevant for short period of time, such as Super Bowl, Football World cup, etc., may attract users that provide intense engagement during the short period and then may die out or be archived. The archived content may be revived and used for subsequent interactions by the same set of users or by other users. As mentioned earlier, each group may include one or more sub-themes and the interactions under each sub-theme are collected for each sub-theme under the main theme. Thus, the generator module provides a collaboration tool that enables accumulation of knowledge based on the specific theme, share the knowledge base with other users on a perpetual basis, and link articles, events, books, videos, etc., for other users to access and share. The group can be either a public group or a private group. With a private group, the users are able to access the content and participate in the group by invitation only, whereas the public group, any user who is interested in the theme can access the content and participate in the group. The policies and principles defined for the group will determine the entry and exit/filtering-out criteria for the users in the group.

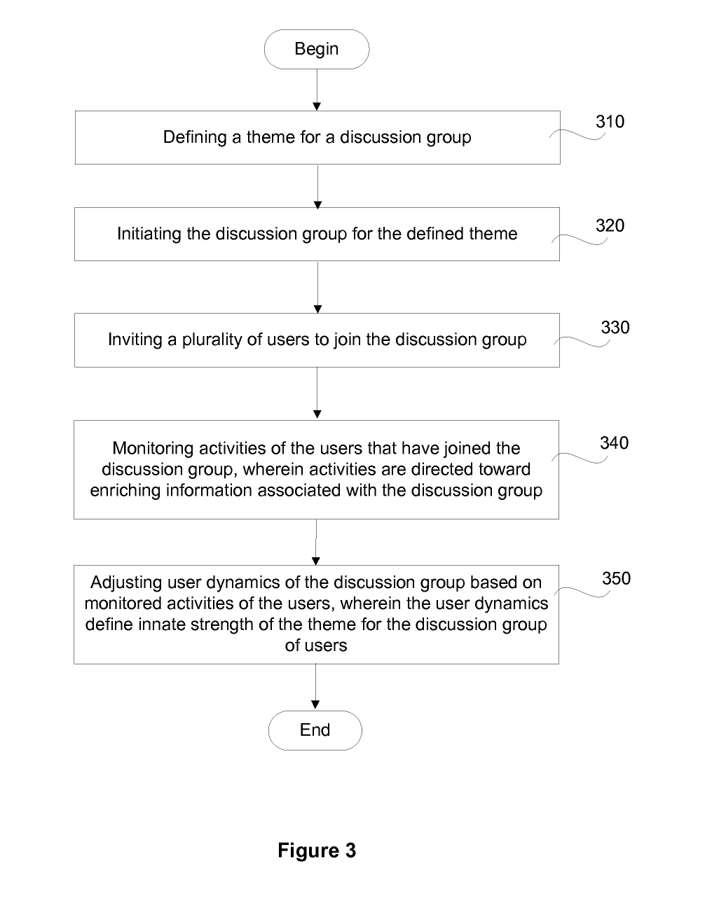

With the above detailed description of the various embodiments, methods for initiating and sharing a private conversation for a content article published on a website will now be described with reference to FIG. 3. FIG. 3 illustrates process flow operations for generating a dynamic group. An application to generate the dynamic group may be accessed through a mobile device as a mobile application or through a desktop or other computing device by accessing a website. As illustrated in FIG. 3, the process begins at operation 310, wherein a defined theme for starting a group is received from a user. In addition to the theme, the user may also provide one or more attributes for defining the group for the requested theme. The attributes may include attributes related to the user requesting the group and theme/group related attributes. A group is initiated for the defined theme using the one or more attributes, as illustrated in operation 320. Initiation of the group includes creating a group for the theme, defining policies and principles for governing the various user interactions, identifying users for joining the group and inviting the users for joining and participating in the group. A generator module executing on the server device receives the theme and the one or more attributes and creates the group accordingly. In one embodiment, the attributes may include information related to the type of group, such as private or public group, that is requested by the user. The attributes may also include rules of interactions. The generator module identifies and applies one or more policies and principles to comply with the defined rules for the defined theme. The generator module also identifies one or more users to join the group. In one embodiment, the generator module may receive a list of users to invite for joining and participation in the group directly from the requesting user. In another embodiment, the generator module may identify a list of users that are direct connects of the requesting user by accessing address book, friends list, etc., of the requesting user. In this embodiment, once the users are identified from the address book/friends list, the generator module may forward the list of users to the requesting user, receive the selection and forward an invitation to the selected list of users to join and participate in the group, as illustrated in operation 330.

The generator module then monitors all the interactions within the group, as illustrated in operation 340. The monitoring of interactions includes ensuring that the interactions follow the defined policies and principles. The interactions may include generation and sharing of content, comment or rating the content, etc., using myriad of tools, such as email tool, photo uploading and sharing tool, video uploading and sharing tool, weblog tools, instant message tool or messenger tool, ratings tool, online deal tool, etc., to generate content that include emails, photo shows, video clips/shows, comments, blogs, messages, pulses, ratings, reviews, memberships, movies, deals, etc. The interactions from each user are gathered and used to adjust the user dynamics of the group. The generator module gathers the interactions and computes a participation score for each user. As mentioned earlier, the generator module may weigh various types of interactions differently and compute the participation score based on the type and frequency of the interaction. The participation score for each user may vary over time and reflects the level of interest of the user to the s occurring under each sub-theme and the defined theme within the group. Using the participation score, the generator module filters the users of the group dynamically. The dynamic filtering inactivates or filters out the inactive contributors that do not add any value to the group. The resulting group identifies a list of users who are active and serious contributors within the group enriching the content and adding value to the group.

The continuous monitoring and dynamic filtering enables the group to either shrink by filtering users or through de-merging so as to only include active users for the defined theme. The groups may also grow in size through mergers/users joining the group. The resulting group has rich content that caters to the interest of the users. The group that lasts longer is the one that has active participants with active theme and provides better content relevance. As a result, the group can be a hot spot for focused promotional target, and thereby for potentially huge monetization realization. As mentioned earlier, the current embodiments also provide the ability to archive the contents for a group that has reduced in size or lacks active contributing users so that the content can be retrieved and the group reactivated. The archiving and reactivation allows for preserving the rich content collected for the theme over time for later retrieval and sharing.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations can include the physical transformations of data, saving of data, and display of data. These operations are those requiring physical manipulation of physical quantities. Usually, though not necessarily, these quantities take the form of electrical or magnetic signals capable of being stored, transferred, combined, compared and otherwise manipulated. Data can also be stored in the network during capture and transmission over a network. The storage can be, for example, at network nodes and memory associated with a server, and other computing devices, including portable devices.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for generating a dynamic group, comprising:
defining a theme for the group;
initiating the group for the defined theme;
inviting a plurality of users to join the group;
monitoring activities of the users that have joined the group, wherein the activities are directed toward sharing information associated with one or more sub-themes of the defined theme; and
adjusting user dynamics of the group based on the monitored activities of the users, wherein the adjusted user dynamics and monitored activities of the users define a strength value of the theme for the group of users.

2. The method of claim 1, wherein adjusting user dynamics further includes,
determining participation score for each user in the group based on number of activities associated with each of the respective users in relation to each of the sub-themes in the group, the participation score of each of the users varying over time to reflect varying level of interest of the respective users to the theme; and
filtering the users in the group dynamically based on the participation score of the respective users.

3. The method of claim 2, wherein filtering further includes,
automatically unsubscribing a particular user when the participation score of the particular user falls below a predefined threshold value, wherein the unsubscribing includes preventing access to the information within the group.

4. The method of claim 1, further includes,
identifying a plurality of groups having the theme; and
merging at least a first group into a second group of the plurality of groups based on a merger indicator, the users of the first group following policies and principles set forth in the second group, wherein the merger indicator is defined by user action.

5. The method of claim 1, wherein monitoring further includes,
archiving information collected in the group over time, when number of activities in the group fall below a predefined threshold value; and
deactivating the group so as to prevent further interaction amongst the users in the group.

6. The method of claim 5, further includes,
detecting requests to access information collected in the deactivated group over time, from one or more new users;
retrieving the information related to the deactivated group from the archives; and
reactivating the deactivated group in response to the requests from the new users, the reactivation enabling the new users to access the retrieved information and to allow interaction between the one or more new users in relation to the one or more sub-themes or the theme of the group, wherein the interaction further enhancing the information related to the group.

7. The method of claim 1, wherein monitoring further includes,
deleting information and the group when number of activities in the group fall below a predefined threshold value.

8. The method of claim 1, wherein initiating of the group is through one of an application or a webpage hosted on a website.

9. The method of claim 1, further includes,
presenting a promotional content to the users of the group, the promotional content directed toward anyone or combination of the sub-theme, theme and activities of the users associated with the group.

10. The method of claim 1, wherein the group can be one of a private group or a public group, and wherein the activities of the users in the group adhere to policies and principles set forth for the group.

11. The method of claim 2, wherein the strength value of the theme for the group is computed as a function of participation score of the users.

12. A non-transitory computer readable medium having program instructions for generating dynamic group, comprising:
program instructions for defining a theme for the group;
program instructions for initiating the group for the defined theme;
program instructions for inviting a plurality of users to join the group;
program instructions for monitoring activities of the users that have joined the group, wherein the activities are directed toward sharing information associated with one or more sub-themes of the defined theme; and
program instructions for adjusting user dynamics of the group based on the monitored activities of the users, wherein the adjusted user dynamics define a strength value of the theme for the group of users.

13. The computer readable medium of claim 12, wherein determining dynamics includes,
program instructions for determining participation score for each user in the group based on number of activities associated with each of the respective users in relation to each of the sub-themes in the group, the participation score of each of the users varying over time to reflect varying level of interest of the respective users to a specific sub-theme or the theme;
program instructions for filtering the users in the group dynamically based on the participation score of the respective users.

14. The computer readable medium of claim 13, wherein filtering further includes,
program instructions for automatically unsubscribing a particular user when the participation score of the particular user falls below a predefined threshold value, wherein the unsubscribing includes preventing access to information within the group.

15. The computer readable medium of claim 12, further includes,
program instructions for identifying a plurality of groups having the theme; and
program instructions for merging at least a first group into a second group of the plurality of groups based on a merger indicator, the users of the merged first group following policies and principles set forth in the second group, wherein the merger indicator is defined by user action.

16. The computer readable medium of claim 12, wherein monitoring further includes,
program instructions for archiving information collected in the group over time, when number of activities in the group fall below a predefined threshold value; and
program instructions for deactivating the group so as to prevent further interaction amongst the users in the group.

17. The computer readable medium of claim 16, further includes,
program instructions for detecting requests to access the information collected in the deactivated group over time, from one or more new users;
program instructions for retrieving information related to the deactivated group from the archives; and
program instructions for reactivating the deactivated group in response to the requests from the new users, the reactivation enabling the new users to access the retrieved information and to allow interaction between the one or more new users in relation to the any one or more of sub-themes or the theme of the group, wherein the interaction further enhancing the enriched information of the group.

18. A system for generating dynamic group, comprising:
a dynamic group generator module executing on a server, the dynamic group generator configured to,
initiate a group for a theme defined by a user;
invite a plurality of users to join the group, the invitation being forwarded to the plurality of users identified as direct connections of the user;
monitor activities of the invited users that have joined the group, wherein the activities are directed toward sharing of information associated with one or more sub-themes of the defined theme;
computing participation score of each user in the group based on number of activities of the corresponding user; and
adjust user dynamics of the group based on the computed participation score associated with the plurality of users, the adjusted user dynamics defining a strength value of the theme for the group.

19. The system of claim 18, further includes,
a group database configured to store information related to the group, wherein the information stored in the group database includes one or more of, the user dynamics of the group, the activities of the users that have joined the group and the information provided for the sub-themes and the theme associated with the group.
